(19) United States
(12) Patent Application Publication
(10) Pub. No.: US 2026/0298477 A1
(43) Pub. Date: Oct. 1, 2026

(54) APPARATUS AND METHOD FOR CONTROLLING COOKING APPLIANCE

(71) Applicant: LG ELECTRONICS INC., Seoul (KR)

(72) Inventors: Hyunwook MOON, Seoul (KR); Jaekyung YANG, Seoul (KR); Dongseong KWAG, Seoul (KR); Myeong Jun SHIN, Seoul (KR)

(73) Assignee: LG ELECTRONICS INC., Seoul (KR)

(21) Appl. No.: 19/544,301

(22) Filed: Feb. 19, 2026

(30) Foreign Application Priority Data
Mar. 26, 2025 (KR) 10-2025-0038665

(51) Int. Cl. F24C 7/08; H05B 1/02

(52) U.S. Cl. CPC F24C 7/086; H05B 1/0266

(57) ABSTRACT

Disclosed is an apparatus for controlling a cooking appliance. In response to that a knock-on function matching knock information is identified as corresponding to an operation of copying operation information of a heating zone, the apparatus determines a first heating zone whose operation information is to be copied, based on a container detection signal, and determines a second heating zone, based on at least one of the container detection signal and a vibration detection signal, and operates the second heating zone using the copied operation information of the first heating zone.

### CROSS-REFERENCE TO RELATED APPLICATION

This application claims priority from Republic of Korea Patent Application No. 10-2025-0038665 filed on Mar. 26, 2025 in the Korean Intellectual Property Office, which is hereby incorporated by reference in its entirety.

### BACKGROUND

### Field

The present disclosure relates to an apparatus and a method for controlling a cooking appliance including a cooktop.

### Description of Related Art

A cooking appliance is one of home appliances for cooking food, and is an apparatus installed in a kitchen space to cook food according to a user's intention. The cooking appliance includes an oven, a microwave, and a cooktop.

A cooktop among the cooking appliances is configured to heat food contained in a cooking container using at least one heating zone. In addition, the cooktop may be implemented alone, or may be implemented in the form of an oven range including an oven under the cooktop.

In the cooktop, on/off, heating intensity, and a timer duration of the heating zone may be adjusted by a user’s manipulation of a knob or button provided on a control panel. For example, the user may select a heating zone to be used by pressing a heating zone selection button provided on the control panel, and may adjust the heating intensity by pressing a heating intensity adjustment button.

Usually, the cooktop is used during a cooking process. Therefore, it is often necessary for the user to manipulate the control panel in a state in which food residue is present on the user's hand. At this time, the control panel may be contaminated with the food residue on the hand, which may cause a manipulation failure.

In this regard, Korean Patent No. 10-2656247 (2024.04.09) is disclosed as a prior art. According to the prior art, when the user knocks on a home appliance, the knock is detected

such that a lamp installed inside an accommodation space is turned on, so that the user positioned out of the home appliance may see the inside of the accommodation space through a see-through window.

The prior art has a technical purpose to identify information about the food received in the inner space without energy loss in the home appliance in which the outer and inner spaces are separated from each other, and fails to disclose controlling a unique function of the home appliance using a knock.

### Prior Art Literature

[Patent Document] Document 1: Korean Patent No. 10-2656247 (2024.04.09)

### SUMMARY

A technical purpose of the present disclosure is to provide an apparatus and a method for controlling a cooking appliance capable of controlling an operation of copying operation information on a heating zone of a cooktop only by a manipulation in which a user knocks an upper plate of the cooktop during a cooking process.

In addition, a technical purpose of the present disclosure is to provide an apparatus and a method for controlling a cooking appliance capable of accurately determining a heating zone to be operated based on the copied operation information by accurately determining the position of a knock input based on a ratio between a magnitude of vibration resulting from the knock input and a reference magnitude.

The purposes of the present disclosure are not limited to the above-mentioned purposes, and other purposes and advantages of the present disclosure that are not mentioned may be understood based on the following descriptions, and will be more clearly understood based on the embodiments of the present disclosure. In addition, it will be readily appreciated that the purposes and advantages of the present disclosure may be realized by means indicated in the claims and combinations thereof.

An apparatus and a method for controlling a cooking appliance according to the present disclosure may control an operation of copying operation information about a heating zone of the cooktop only via knocking on a top plate of the cooktop.

Specifically, in response to that it is identified that a knock-on function matching knock information corresponds to an operation of copying heating zone operation information, the control apparatus of the cooking appliance may be configured to determine a first heating zone whose operation information is to be copied, based on a container detection signal, to copy the operation information of the first heating zone, and to operate a second heating zone using the copied operation information of the first heating zone.

In addition, the control apparatus of the cooking appliance may be configured to identify a knock position based on the vibration detection signal, and determine the heating zone corresponding to the knock position as the second heating zone.

In addition, the control apparatus of the cooking appliance may be configured to identify the knock position based on a ratio between a magnitude of a reference value defined in the knock information and a magnitude of the vibration detection signal.

According to an embodiment of the present disclosure, an apparatus for controlling a cooking appliance includes: a vibration sensor configured to detect vibration resulting from at least two times of knocks and provide a vibration detection signal corresponding to the detected vibration to a controller; a container detection sensor configured to detect a cooking container and provide a container detection signal to the controller; and the controller configured to: identify a knock-on function matching preset knock information, based on the received vibration detection signal; determine a first heating zone whose operation information is to be copied, based on the received container detection signal; copy the operation information of the first heating zone; and operate a second heating zone using the copied operation information of the first heating zone.

According to an embodiment of the present disclosure, a method for controlling a cooking appliance includes: identifying a knock-on function matching preset knock information, based on a vibration detection signal received from a vibration sensor; determining a first heating zone whose operation information is to be copied, based on a container detection signal received from a container detection sensor; copying the operation information of the first heating zone; determining a second heating zone, based on at least one of the container detection signal or the vibration detection signal, wherein the second heating zone is a heating zone to operate using the copied operation information of the first heating

zone; and operating the second heating zone using the copied operation information of the first heating zone.

As described above, according to the present disclosure, the operation information of the operating heating zone may be copied and another heating zone may be operated using the copied operation information, only via the manipulation of the user knocking on the top plate of the cooktop while performing the cooking process.

In addition, the control apparatus and the control method of the present disclosure may accurately determine the heating zone whose operation information is to be copied, based on the container detection signal.

In addition, the control apparatus and the control method of the present disclosure may identify the knock position based on the vibration detection signal, and determine the heating zone corresponding to the knock position as the heating zone to be operated using the copied operation information.

In addition, the control apparatus and the control method of the present disclosure may accurately determine the location of the knock based on the ratio between the magnitude of the vibration defined in the knock information and the magnitude of the vibration detection signal, thereby accurately determining the heating zone to be operated using the copied operation information.

In addition, the control apparatus and the control method of the present disclosure may control the operation of copying the operation information on the heating zone of the cooktop via the manipulation of the user knocking on the top plate of the cooktop while performing the cooking process, thereby improving user convenience.

The effects of the present disclosure are not limited to the effects mentioned above, and other effects not mentioned will be clearly understood by those skilled in the art from the following descriptions.

### BRIEF DESCRIPTION OF DRAWINGS

FIG. 1 is a perspective view illustrating a cooking appliance according to an embodiment of the present disclosure.

FIG. 2 is a plan cross-sectional view showing an internal structure of the cooking appliance illustrated in FIG. 1.

FIG. 3 is a bottom view illustrating an internal structure of the cooking appliance illustrated in FIG. 1.

FIG. 4 is an example diagram of a heating zone and a control panel of a cooking appliance according to an embodiment of the present disclosure.

FIG. 5 is a block diagram of a control apparatus of a cooking appliance according to an embodiment of the present disclosure.

FIG. 6 is an example diagram of a vibration detection signal resulting from a knock input in the cooking appliance according to an embodiment of the present disclosure.

FIG. 7 is a knock-on setting flowchart of a cooking appliance according to an embodiment of the present disclosure.

FIG. 8 is an example of a knock-on setting screen of a cooking appliance according to an embodiment of the present disclosure.

FIGS. 9A, 9B, and 9C are diagrams illustrating a control flow of an operation of turning on/off cooktop power corresponding to the knock-on function of the cooking appliance.

FIG. 10 shows a knock-on function map table set in a cooking appliance according to embodiments of the present disclosure.

FIGS. 11A and 11B are diagrams illustrating a control flow of an operation of turning off a most recently-set heating zone corresponding to the knock-on function of the cooking appliance.

FIGS. 12A and 12B are diagrams illustrating a control flow of an operation of turning off a specific heating zone corresponding to the knock-on function of the cooking appliance.

FIGS. 13A and 13B are diagrams illustrating a control flow of an operation of activating/deactivating temporary reduction of heating intensity corresponding to the knock-on function of the cooking appliance.

FIGS. 14A, 14B and 14C are diagrams illustrating a control flow of an operation of heating intensity reduction corresponding to the knock-on function of the cooking appliance.

FIGS. 15A and 15B are diagrams illustrating a control flow of an operation of setting the maximum heating intensity corresponding to the knock-on function of the cooking appliance.

FIG. 16 is a diagram illustrating a control flow of an operation of setting/releasing a lock corresponding to the knock-on function of the cooking appliance.

FIGS. 17A, 17B and 17C are diagrams illustrating a control flow of an operation of setting a timer duration corresponding to the knock-on function of the cooking appliance.

FIGS. 18A and 18B illustrate one embodiment of a control flow of an operation of copying heating zone information corresponding to the knock-on function of the cooking appliance.

FIGS. 19A and 19B illustrate another embodiment of a control flow of an operation of copying heating zone information corresponding to the knock-on function of the cooking appliance.

### DETAILED DESCRIPTIONS

The above-described purposes, features, and advantages will be described in detail with reference to the accompanying drawings, and accordingly, a person having ordinary skill in the art to which the present disclosure pertains will be able to easily implement the technical idea of the present disclosure. In the description of the present disclosure, when it is determined that a detailed description of a known technology related to the present disclosure may unnecessarily obscure the gist of the present disclosure, the detailed description will be omitted. Hereinafter, preferred embodiments according to the present disclosure will be described in detail with reference to the accompanying drawings. In the drawings, the same reference numerals are used to indicate the same or similar components.

Although the first, second, and the like are used to describe various components, it is obvious that these components are not limited by these terms. These terms are used to distinguish only one component from another component. Unless otherwise stated, the first component may be the second component.

The present disclosure is not limited to the embodiments disclosed below, but various changes may be applied thereto and the present disclosure may be implemented in various different forms. However, the present embodiment is provided so that the present disclosure is complete and the scope of the present disclosure is fully informed to those skilled in the art. Therefore, embodiments of the present disclosure are not limited to the embodiments disclosed below, but it should be understood that a configuration of one embodiment and a configuration of another embodiment are substituted with each other or are added to each other, and all changes, equivalents, and substitutes included in the technical spirit and scope of the present disclosure are included in the present disclosure.

The accompanying drawings are only set forth for easy understanding of the embodiments disclosed in the present disclosure, and the technical spirit disclosed in the present disclosure is not limited by the accompanying drawings, and it should be understood that all changes, equivalents, and substitutes included in the spirit and technical scope of the present disclosure are included in the present disclosure. In the drawings, the components may be expressed to be larger or smaller in size or thickness in consideration of convenience of understanding, etc. However, the scope of the present disclosure should not be limited thereto.

The terms used herein are used only to describe specific embodiments or embodiments, and are not intended to limit the present disclosure. As used herein, the singular constitutes "a" and "an" are intended to include the plural constitutes as well, unless the context clearly indicates otherwise In the present disclosure, terms such as "include" and "comprise" are intended to designate that a feature, a number, a step, an operation, a component, a part, or a combination thereof as described in the present disclosure exist. That is, it should be understood that in the present disclosure, the terms such as "include" and "comprise" do not exclude the presence or addition of one or more other features, numbers, steps, operations, components, parts, or combinations thereof.

Terms including ordinals, such as first, second, etc., may be used to describe various components, but the components are not limited by the terms. The terms are used only for the purpose of distinguishing one component from another component.

When it is mentioned that one component is "connected" or "coupled" to another component, it should be understood that one component may be directly connected or coupled to another component, or still another component may be present therebetween. On the other hand, when it is mentioned that one component is "directly connected" or "directly coupled" to another component, it should be understood that still another component is absent therebetween.

When one component is referred to as "being disposed on top of" or "being disposed under" another component, it should be understood that one component may be directly disposed on top of or under another component or still another component may be present therebetween.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A position at which a door is installed in a state in which the cooking appliance is placed on the floor is defined as a front position around a center of the cooking appliance. Therefore, a direction in which a container is inserted into an inner space of the cooking appliance in a state in which the door is defined as a rearward direction. For convenience, a front-rear direction may be referred to as a first direction.

In addition, a horizontal direction orthogonal to the front-rear direction of the cooking appliance, that is, a width direction of the cooking appliance in a state in which the cooking appliance is viewed in front of the door of the cooking appliance may be referred to as a left-right direction. For convenience, the left-right direction may be referred to as a second direction. In addition, the width direction of the cooking appliance may be referred to as a lateral direction. In addition, the width direction of the cooking appliance may be referred to as a longitudinal direction. In this regard, the front-rear direction may be referred to as a transverse direction.

In addition, the direction of gravity may be defined as a downward direction, and the direction opposite to the direction of gravity may be defined as an upward direction. In addition, the up-down direction may be referred to as a third direction. In addition, the above-described up-down direction may be referred to as a vertical direction.

Throughout the present disclosure, "A and/or B" means A, B, or A and B, unless otherwise specified, and "C to D" means being equal to or greater than C and being equal to or smaller than D unless otherwise specified.

Hereinafter, provided are an apparatus and a method for controlling a cooking appliance capable of controlling some operations of a cooktop only by a manipulation in which a user knocks an upper plate of the cooktop during a cooking process.

In the present disclosure, knock information may be defined as at least one reference value and at least one reference period generated based on a magnitude and an interval of a knock detection signal resulting from at least two knocks. In the present disclosure, the knock information may also be referred to as a knock fingerprint.

For example, in the knock information, a first reference value may be set based on a magnitude of a first vibration detection signal resulting from a first knock, second and third reference values may be set based on a magnitude of a second vibration detection signal resulting from a second knock, and at least one reference period may be set based on an interval between the first knock and the second knock. In this regard, the third reference value may be set based on a magnitude of a residual vibration signal detected after a predetermined period of time has elapsed after the second knock, the second reference value may be set to a value greater than the first reference value, and the third reference value may be set to a value smaller than the first reference value.

In the present disclosure, a knock-on function may be defined as an operation of controlling the operation of the cooktop in response to the user's knock.

In the present disclosure, in the knock information (or the knock fingerprint), at least one of an operation of turning on or off cooktop power, an operation of turning off a most recently-set heating zone, an operation of turning off a specific heating zone, an operation of activating/deactivating temporary reduction of a heating intensity, an operation of lowering a heating intensity, an operation of setting a maximum heating intensity, an operation of setting/releasing a lock, an operation of setting a timer duration, and an operation of copying heating zone information may be set to correspond to the knock-on function.

In the present disclosure, the operation of copying the heating zone information using the knock-on function may be defined as an operation of activating or operating a new second heating zone based on operation information of a first heating zone in an operating or activated state. In this regard, the operation information of the heating zone may include at least one of a heating intensity level and a timer duration.

### OVERALL STRUCTURE OF COOKING APPLIANCE

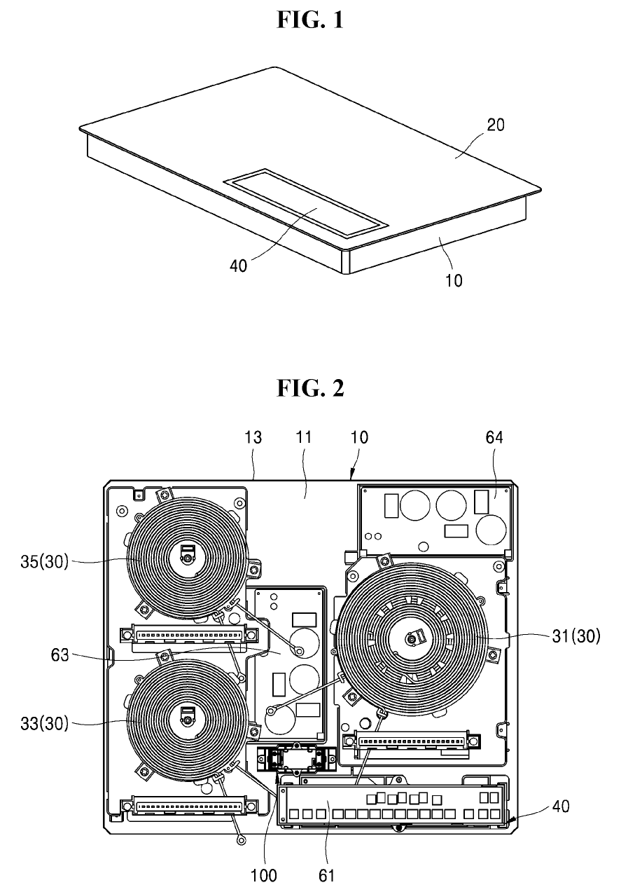

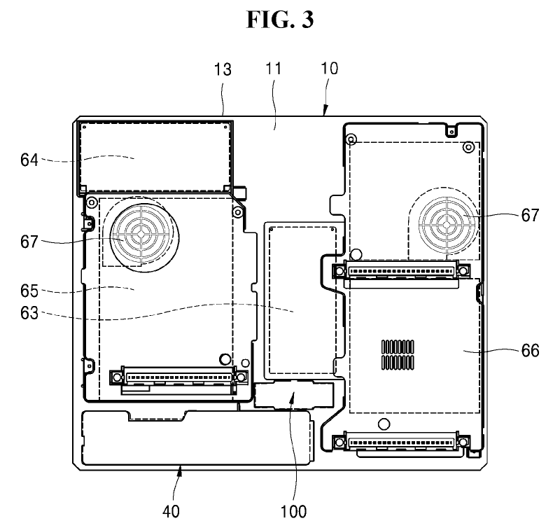

FIG. 1 is a perspective view illustrating a cooking appliance according to an embodiment of the present disclosure. FIG. 2 is a plan cross-sectional view showing an internal structure of the cooking appliance illustrated in FIG. 1. FIG. 3 is a bottom view illustrating an internal structure of the cooking appliance illustrated in FIG. 1.

Referring to FIGS. 1-3, the cooking appliance may include a cooktop casing 10 and a top plate 20. According to the present embodiment, an outer shape of the cooking appliance may be defined by the cooktop casing 10 and the top plate 20. The cooktop casing 10 may be disposed under the top plate 20 and may constitute a front surface, a rear surface, a side surface, and a bottom surface of the cooking appliance provided in the form of a cooktop. The top plate 20 may constitute an upper end of the cooking appliance and may define an upper appearance of the cooking appliance.

An accommodation space may be formed inside the cooktop casing 10. The accommodation space formed inside the cooktop casing 10 may be opened upwards. In an example, the cooktop casing 10 may be formed in a hexahedral shape with an open upper side. Various internal components constituting the cooking appliance may be accommodated in the accommodation space defined by the top plate 20 and the cooktop casing 10.

According to the present embodiment, the cooktop casing 10 may include a bottom portion 11. The bottom portion 11 may constitute a bottom surface of the cooktop casing 10 and may define a lower boundary surface of the accommodation space. The bottom portion 11 may be disposed under the top plate 20 and may have a plane parallel to the top plate 20.

In addition, the cooktop casing 10 may include a sidewall portion 13. The sidewall portion 13 may constitute a front surface, a rear surface, and both opposing side surfaces of the cooktop casing 10, and may be formed in a vertical wall shape extending upwards from an edge of the bottom portion 11. The sidewall portion 13 may define a horizontal boundary surface of the accommodation space.

In addition, the cooking appliance may be provided with a heating unit 30 for heating food to be cooked or a container (hereinafter referred to as an "object to be heated or a heating target") containing therein food. At least one heating unit 30 may be provided in the cooking appliance. For example, each heating unit 30 may be provided in a form including a heating coil or a working coil using electricity.

In an example, at least a portion of the heating unit 30 may be disposed in the accommodation space. For example, the heating unit 30 may be disposed in a space surrounded with the cooktop casing 10 and the top plate 20, and may be disposed under the top plate 20. The heating unit 30 may heat the object to be heated or the heating target seated on the top plate 20.

In this embodiment, an example is illustrated in which the cooking appliance is provided in the form of an induction heating cooking appliance. The heating unit 30 of the cooking appliance may be provided in a form including a heating coil. As such, the heating unit 30 including the heating coil may be operated using a high-frequency current applied from an inverter to generate a strong magnetic field line.

As described above, the magnetic field line generated by the heating unit 30 including the heating coil may generate an eddy current in the container. Thus, as the eddy current flows through the container, the heat may be generated to heat the container. As the container is heated, the food contained in the container may be heated.

Various electronic/electrical components may be installed inside the cooking appliance, that is, in the accommodation space. The electronic/electrical components disposed in the accommodation space may include at least one of a main PCB (printed circuit board) 61, a power circuit, and a driving circuit, and may be provided in a form of a circuit board electrically connected to the heating coil of the heating unit 30.

For example, the main PCB may be configured to control the overall operations of the cooking appliance, and may be disposed in a control panel 40. In addition, the power circuit is configured to supply power to the heating coil, and the power circuit may include a switching mode power supply in SMPS), a noise filter (EMI filter) 63, etc. The driving circuit is configured to drive the heating coil, and the driving circuit may include an inverter PCB 65.

In addition, a cooling fan 67 may be disposed inside the cooking appliance. The cooling fan 67 serves to cool the electronic/electrical components by introducing external air into the cooktop casing 10 and supplying the external air to the accommodation space. In an example, the cooling fan 67 may be disposed under the inverter PCB 65, and the cooling fan 67 may effectively cool high heat generation components such as IGBT provided in the inverter PCB 65.

After cooling the electronic/electrical components in the accommodation space, the external air introduced into the cooktop casing 10 under the operation of the cooling fan 67 may be discharged to the outside out of the cooking appliance through an exhaust hole defined in the side surface or the rear surface of the cooktop casing 10. In this embodiment, an example is illustrated in which the exhaust hole is disposed in the rear surface of the cooktop casing 10.

In addition, the cooking appliance of the present embodiment may include the control panel 40. The control panel 40 may be disposed in the top plate 20. The control panel 40 may be provided with a manipulator including various switches for adjusting the operation of the cooking appliance. In addition, the control panel 40 may further include a display for displaying an operating state of the cooking appliance.

In an example, at least a portion of the control panel 40 may be disposed in the accommodation space. For example, the control panel 40 may be disposed in a space surrounded with the cooktop casing 10 and the top plate 20, and may be disposed under the top plate 20. The heating unit 30 may heat the object to be heated or the heating target seated on the top plate 20.

In addition, according to the present embodiment, the control panel 40 may be disposed in front of the heating units 30 provided in the cooking appliance in the plan view. For example, in the front-rear direction, the control panel 40 may be disposed between the frontmost heating unit of the heating units 30 and the front surface of the cooktop casing 10. That is, the control panel 40 may be disposed at a position very adjacent to the front surface of the cooking appliance.

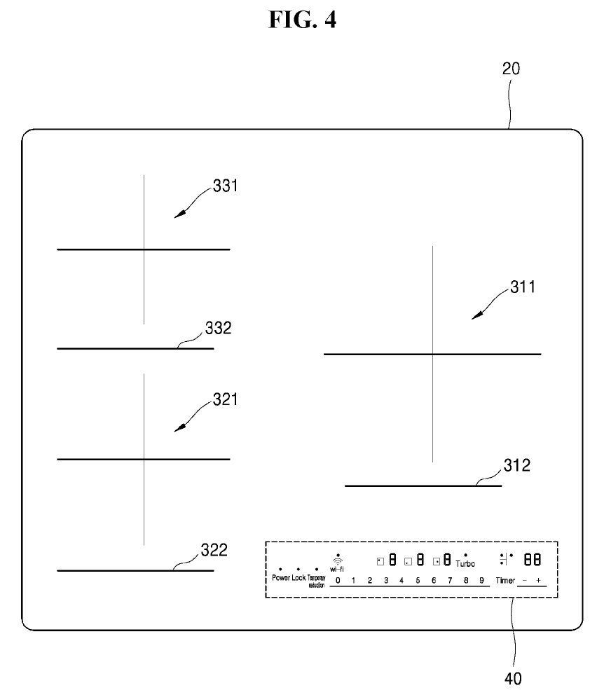

FIG. 4 is an example diagram of a heating zone and a control panel of a cooking appliance according to an embodiment of the present disclosure.

For example, as illustrated in FIG. 4, three heating zones 311, 321, and 331 and the control panel 40 may be disposed in the top plate 20 of the cooking appliance. In addition, indicator lights 312, 322, and 332 respectively indicating a heating-ready state of the three heating zones 311, 321, and 331 may be disposed in the top plate 20.

Buttons for selecting an operation of the cooktop may be disposed in the control panel 40. For example, buttons for turning on the cooktop power, selecting a heating zone to be activated, selecting a heating zone heating intensity (level), setting and releasing a temporary lowering of the heating intensity, setting and releasing a lock, and setting a timer may be disposed in the control panel.

The user may turn on the cooktop power by pressing a button provided in the control panel 40, may select the heating zone to be activated, and may select the heating intensity of the heating zone. In addition, the user may press a button provided in the control panel 40 to temporarily lower the heating intensity of the heating zone or cancel the temporarily lowering thereof, and to lock or unlock the buttons. In addition, the user may set a cooking time duration using the timer.

When the user manipulates the control panel 40 with a hand contaminated with food ingredients or spices, contamination of the control panel 40 may occur, and there is a possibility that a malfunction of the cooking appliance may occur.

Accordingly, embodiments of the present disclosure are directed to providing a cooking appliance capable of controlling various operations of the cooktop using the knock-on function so as to control the operation of the cooktop in a knock manner, and a method for controlling the same. The knock-on function may be defined as a function capable of controlling the various operations of the cooktop based on a vibration detection signal resulting from a user's knock.

### KNOCK-ON SETTING OF COOKING APPLIANCE

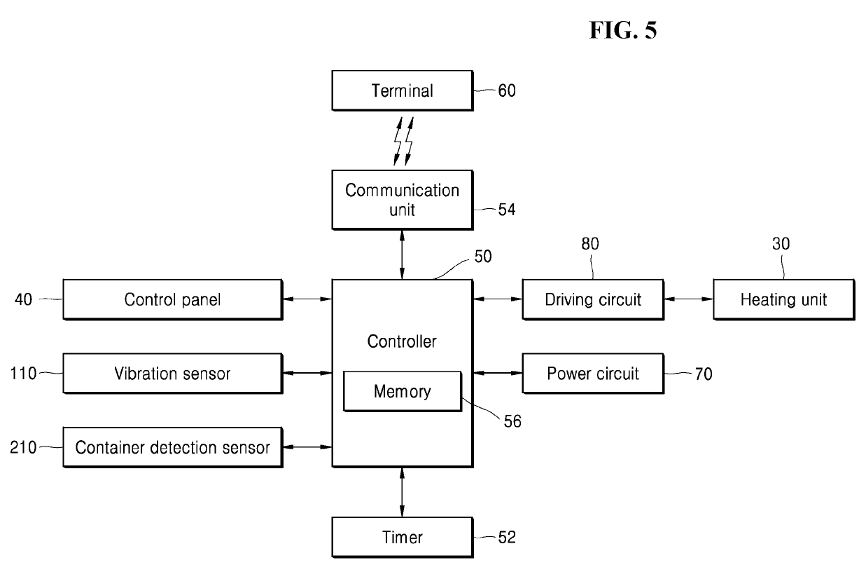

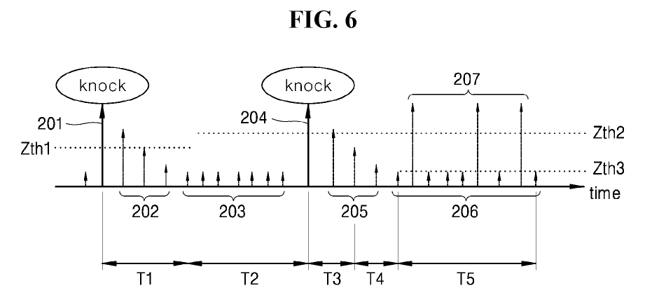

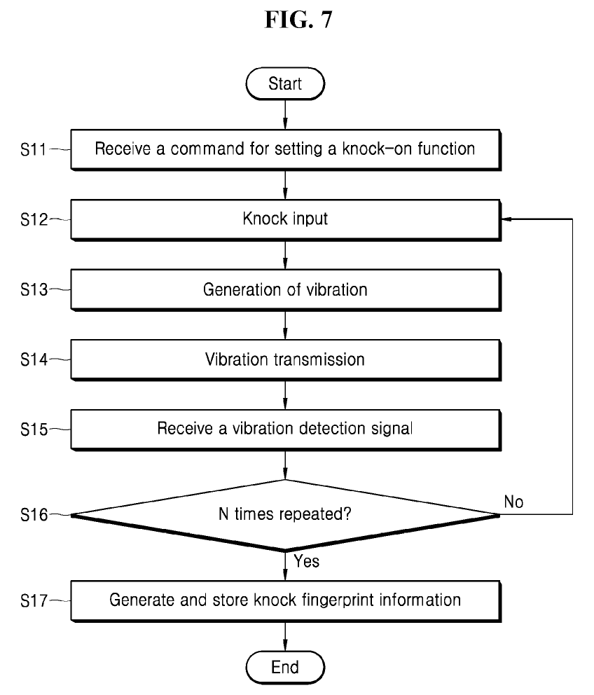

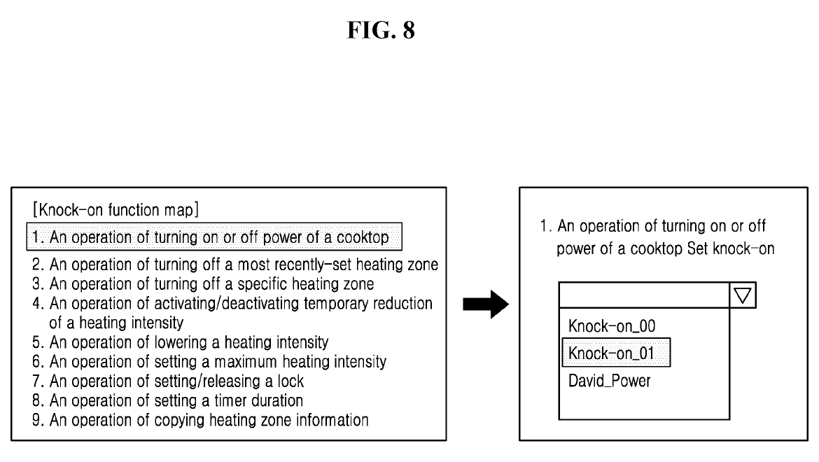

FIG. 5 is a block diagram of a control apparatus of a cooking appliance according to an embodiment of the present disclosure. FIG. 6 is an example diagram of a vibration detection signal resulting from a knock input in the cooking appliance according to an embodiment of the present disclosure. FIG. 7 is a knock-on setting flowchart of a cooking appliance according to an embodiment of the present disclosure. FIG. 8 is an example of a knock-on setting screen of a cooking appliance according to an embodiment of the present disclosure.

Referring to FIGS. 5-8, the control apparatus of the cooking appliance according to an embodiment of the present disclosure may include the control panel 40, a vibration sensor 110, a container detection sensor 210, a controller 50, a memory 52, a communication unit 54, a driving circuit 80, a power circuit 70, and the heating unit 30.

The vibration sensor 110 may detect a vibration generated as a result of the user knocking on the top plate 20, and provide a vibration detection signal corresponding to the detected vibration to the controller 50. For example, the vibration sensor 110 may be embodied as one three-axis acceleration sensor that simultaneously senses vibrations transmitted in three-axis directions orthogonal to each other. The three-axis acceleration sensor may detect minute movement changes of the medium due to vibration in the x, y, and z-axis directions orthogonal to each other using a single sensor.

The container detection sensor 210 may detect the cooking container and provide a container detection signal according to the detection to the controller 50. For example, the container detection sensor 210 may store oscillation energy in the detection coil or may generate an oscillation signal which freely resonates, under the control of the controller 50, and compare the oscillation signal with a reference signal, and provide a container detection signal according to the comparison result to the controller 50. The container detection sensor 210 may be disposed in each of a plurality of heating zones.

The controller 50 may be configured to determine, among the plurality of heating zones, a heating zone on which the container is seated and a heating zone on which the container is not seated, based on the container detection signal received from the container detection sensor 210.

The communication unit 54 may perform communication between the terminal 60 and the controller 50. An application for setting knock-on may be installed in the terminal 60. The communication unit 54 may communicate with the terminal 60 so that the controller 50 may be configured to interwork with the terminal 60 to set the knock-on function.

The heating unit 30 may include the heating coil corresponding to each of the first to third heating zones, a resonant capacitor, and at least one relay. The heating unit 30 may receive the driving current from the driving circuit 80. The driving current from the driving circuit 80 may be supplied, as resonating AC (alternating current), to the heating coil. The resonance frequency of the alternating current may be determined based on inductance of the heating coil and capacitance of the resonant capacitor.

The driving circuit 80 drives at least one of the heating coils corresponding to the first to third heating zones of the heating unit 30 under the control of the controller 50. For example, the driving circuit 80 may include an inverter circuit. The inverter circuit may supply or block the driving current supply to the heating unit 30 using the switching circuit switched under the control of the controller 50.

The power circuit 70 may supply power to the driving circuit 80 under the control of the controller 50. The power circuit 70 may convert AC power into DC power. For example, the power circuit 70 may include a bridge diode and a DC connection capacitor, may convert an AC voltage into a DC voltage having a constant magnitude and polarity using the bridge diode and the DC connection capacitor, and may convert an AC current having the magnitude and flow direction varying over time into a DC current having the constant magnitude.

The controller 50 may be configured to control at least one of the driving circuit 80 or the power circuit 70 based on a manipulation signal input through the button of the control panel 40. In addition, the controller 50 may be configured to also control a display light displaying an operation state of the cooking appliance. In addition, the controller 50 may be configured to include a timer 56, and may control the driving circuit 80 to drive the heating unit 30 based on a cooking time duration of the heating zone selected using the control panel 40.

The controller 50 may be configured to receive a knock-on setting command from the terminal 60 via the communication unit 54. In setting the knock-on, the controller 50 may be configured to generate knock information based on the magnitude and interval of at least two or more vibration detection signals received from the vibration sensor 110. For example, the controller 50 may be configured to receive the vibration detection signal resulting from a collection of at least two knock inputs which is repeated n times from the vibration sensor 110, and average the magnitudes of the vibration detection signals corresponding to n times of the collections to generate the knock information.

The controller 50 may be configured to define at least one reference value Zth1, Zth2, and Zth3 based on the magnitudes of first and second vibration detection signals 201 and 204 resulting from first and second knocks and define at least one reference period T1, T2, T3, T4, and T5 based on at least one residual vibration signal 202, 203, 205, and 206 resulting from the first and second knocks, thereby generating the knock information.

The controller 50 may be configured to define the first reference value Zth1 based on the magnitude of the first vibration detection signal 201 resulting from the first knock. For example, the controller 50 may be configured to define 50% of the magnitude of the first vibration detection signal 201 as the first reference value Zth1.

In addition, the controller 50 may be configured to define the second reference value Zth2 based on the magnitude of the second vibration detection signal 204 resulting from the second knock. For example, the controller 50 may be configured to define 66% of the magnitude of the second vibration detection signal 204 as the second reference value Zth2.

In addition, the controller 50 may be configured to define the third reference value Zth3 based on the magnitude of the residual vibration signal 206 detected when a predetermined period of time has elapsed after the second knock input. For example, the controller 50 may be configured to define the magnitude of the residual vibration signal 206 detected when a predetermined period T3+T5 has elapsed after the second knock input as the second reference value Zth2.

In this regard, the second reference value Zth2 may be set to a value greater than the first reference value Zth1, and the third reference value Zth3 may be set to a value smaller than the first reference value Zth1.

In addition, the controller 50 may be configured to define at least one reference period T1, T2, T3, T4, and T5 based on at least one residual vibration signal 202, 203, 205, and 206 resulting from the first and second knocks.

For example, the first reference period T1 may be defined as a period for which the value of the first residual vibration signal 202 decreases after the first vibration detection signal 201 resulting from the first knock is detected. In addition, the second reference period T2 may be defined as a period for which the value of the second residual vibration signal 203 is maintained after the first reference period T1 has elapsed.

In addition, a combination of the third reference period T3 and the fourth reference period T4 may be defined as a period for which the value of the third residual vibration signal 205 decreases after the second vibration detection signal 204 resulting from the second knock is detected. In addition, the fifth reference period T5 may be defined as a period for which the value of the fourth residual vibration signal 206 is maintained after the combination of the third reference period T3 and the fourth reference period T4 has elapsed.

As described above, the first reference value Zth1, the second reference value Zth2, the third reference value Zth3, and the at least one reference period T1, T2, T3, T4, and T5 resulting from the first and second knocks may be defined in the knock information, and data on the knock information may be stored in the memory 52.

In addition, the controller 50 may be configured to match one of various operations of the cooktop with the knock information to set the knock-on function. For example, the controller 50 may be configured to match, with the knock information, one of various operations of the cooktop including an operation of turning on or off cooktop power, an operation of turning off a most recently-set heating zone, an operation of turning off a specific heating zone, an operation of activating/deactivating temporary reduction of a heating intensity, an operation of lowering a heating intensity, an operation of setting a maximum heating intensity, an operation of setting/releasing a lock, an operation of setting a timer duration, and an operation of copying heating zone information. Thus, the operation matching with the knock information may be set to be controlled using the knock-on function.

A knock-on function map for matching one of the various operations of the cooktop with the knock information may be displayed through the terminal 60. When one of the various operations of the cooktop is selected from the knock-on function map, a menu for storing the knock-on function for each user may be displayed through the terminal 60. In an embodiment of the present disclosure, an example is illustrated in which the knock-on function is guided and set through the terminal 60. However, embodiments of the present disclosure are not limited thereto. In another example, the cooking appliance may include a display device, and may guide and set the knock-on function in conjunction with the display device.

In addition, when the knock-on function setting has been completed, the controller 50 may be configured to control at least one of the power circuit 70 or the driving circuit 80 to control various operations of the cooktop, based on the vibration detection signal detected from the vibration sensor 110.

For example, the controller 50 may be configured to receive the first and second vibration detection signals 201 and 204 resulting from the first and second knocks, compare the first and second vibration detection signals 201 and 204 with the knock information, and determine whether the vibration is caused by the knock onto the top plate 20 or the vibration is not caused by the knock onto the top plate 20, based on the comparison result.

For example, in response to that the first and second vibration detection signals 201 and 204 resulting from the first and second knocks satisfy at least one reference value Zth1, Zth2, and Zth3 and at least one reference period T1, T2, T3, T4, and T5 defined in the knock information, the controller 50 may be configured to determine that the vibration is caused by the knock onto the top plate 20.

In addition, in response to that the vibration detection signal 207 does not satisfy at least one reference value Zth1, Zth2, and Zth3 and at least one reference period T1, T2, T3, T4, and T5 defined in the knock information, the controller 50 may be configured to determine that the vibration detection signal 207 received by the controller 50 does not result from the knock onto the top plate 20.

The controller 50 may be configured to match, with the knock information, at least one of an operation of turning on or off cooktop power, an operation of turning off a most recently-set heating zone, an operation of turning off a specific heating zone, an operation of activating/deactivating temporary reduction of a heating intensity, an operation of lowering a heating intensity, an operation of setting a maximum heating intensity, an operation of setting/releasing a lock, an operation of setting a timer duration, and an operation of copying heating zone information, thereby setting the knock-on function. Thus, the operation matching with the knock information may be set to be controlled using the knock-on function, that is, to correspond to the knock-on function. The controller 50 may be configured to add an additional operation of the cooktop to be controlled using the knock-on function, that is, to be set to correspond to the knock-on function via an update of an application installed in the terminal 60 or the cooking appliance.

After the knock-on setting has been completed, the controller 50 may be configured to identify the knock information based on the first and second vibration detection signals 201 and 204 resulting from the first and second knocks and to perform the operation of the cooktop matching with the identified knock information.

The operation of the cooking appliance for the knock-on function setting will be described as follows.

First, the cooking appliance may receive a command for setting a knock-on function from the terminal 60 in S11. The cooking appliance may guide the user with a message or voice through the terminal 60 so that the user may knock on the top plate 20 at least twice or more.

When the user performs the knocking at least two times, vibration may be generated in S13. The generated vibration may be transmitted to the vibration sensor 110 of the cooking appliance in S14. At this time, the cooking appliance receives the vibration detection signal resulting from the at least two knock inputs through the vibration sensor 110 in S15. The cooking appliance repeatedly performs the above series of steps n times in S16.

The cooking appliance generates knock fingerprint information based on the average of the vibration detection signals resulting from the repeatedly n times performed series of the steps. Then, when one of various operations of the cooktop is selected by the user, the cooking appliance matches the selected operation with the knock fingerprint information in S17.

As described above, according to the present disclosure, the knock information may be generated based on the vibration detection signal resulting from at least two knock inputs, and one of various operations of the cooktop may be matched with the knock information, thereby setting the knock-on function.

In addition, according to the present disclosure, the various operations of the cooktop, including an operation of turning on or off cooktop power, an operation of turning off a most recently-set heating zone, an operation of turning off a specific heating zone, an operation of activating/deactivating temporary reduction of a heating intensity, an operation of lowering a heating intensity, an operation of setting a maximum heating intensity, an operation of setting/releasing a lock, an operation of setting a timer duration, and an operation of copying heating zone information may be matched with the knock information, thereby setting the knock-on function. Thus, the operation matching with the knock information may be set to be controlled using the knock-on function, that is, to correspond to the knock-on function.

In addition, the control apparatus and the control method of the present disclosure may set the knock-on function for each user, that is, provide a user-specific knock-on function.

In addition, the control apparatus and the control method of the present disclosure may control the operation of the cooktop through the user knocking-on the top plate of the cooktop while the cooking process is performed, thereby improving user convenience.

In addition, the control apparatus and the control method of the present disclosure may facilitate the manipulation of the cooktop by matching the operation of the cooktop frequently used by the user with the knock information.

In addition, according to the present disclosure, the knock-on function may be set for each user, that is, the user-specific knock-on function may be provided, such that the operations of the cooktop set to be controlled using the knock-on function may be various.

In addition, the control apparatus and the control method of the present disclosure may add the various operations of the cooktop so as to be controlled using the knock-on function through the update of the application installed in the terminal such as a smartphone or the cooking appliance.

### CONTROL OF KNOCK-ON FUNCTION OF COOKING APPLIANCE

1) Operation of turning on and off cooktop power

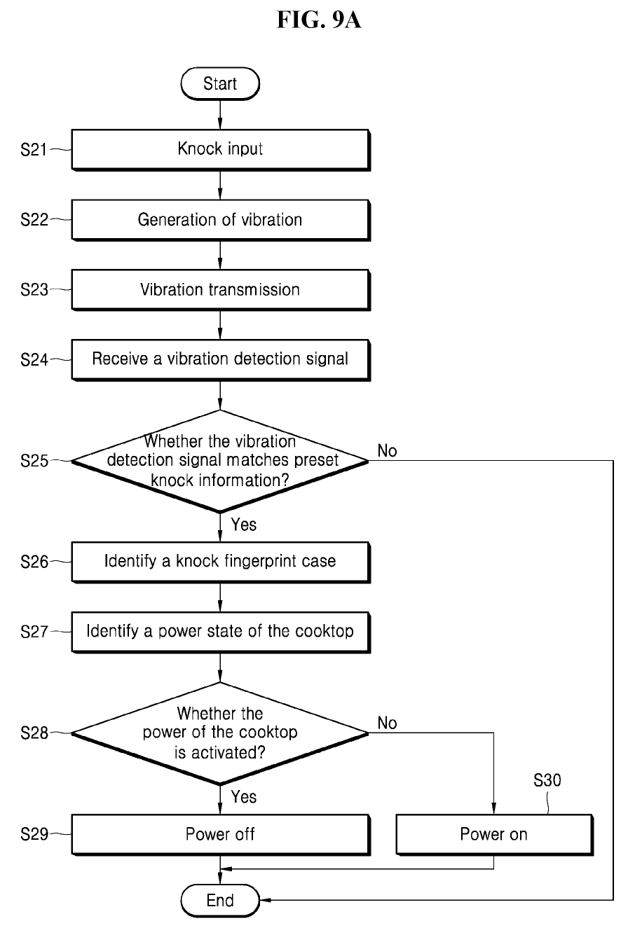

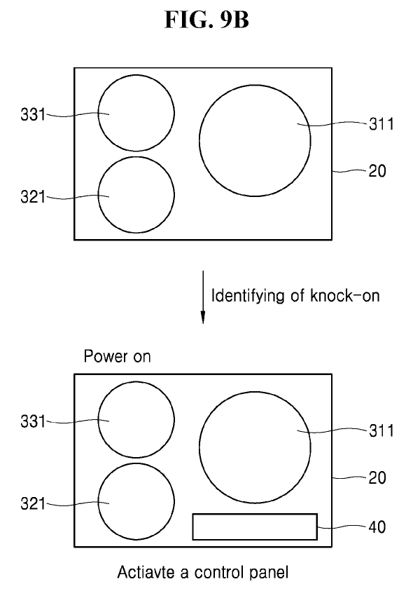

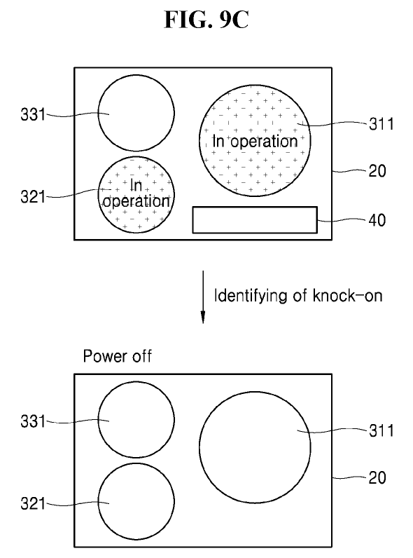

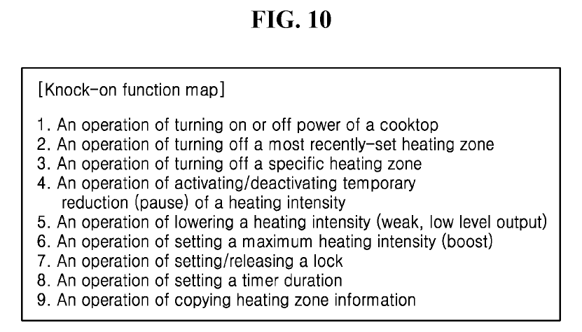

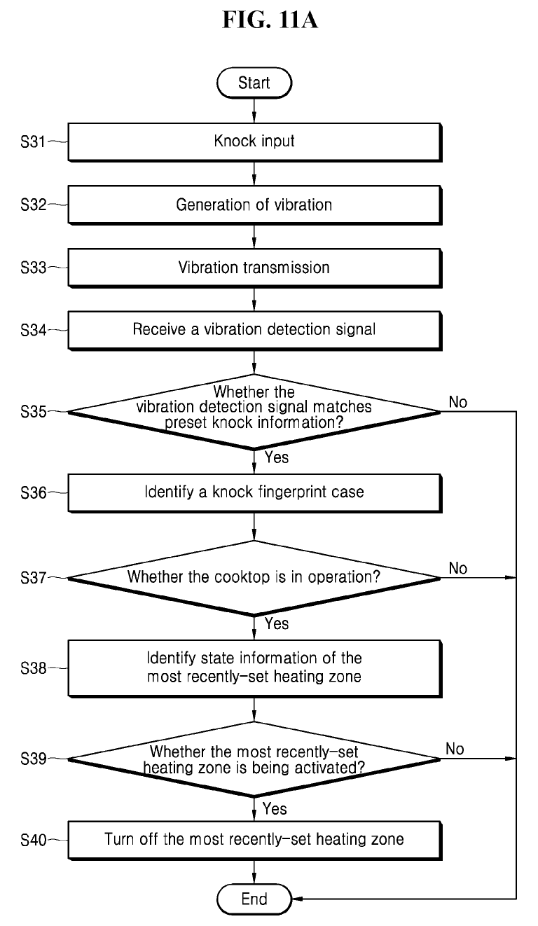

FIGS. 9A, 9B, and 9C, are diagrams illustrating a control flow of an operation of turning on/off the cooktop power corresponding to the knock-on function of the cooking appliance. FIG. 10 shows a knock-on function map table set in a cooking appliance according to embodiments of the present disclosure.

Referring to FIGS. 5, 6, 9A, 9B, 9C, and 10, the vibration sensor 100 detects vibration caused by at least two user knocks and provides a vibration detection signal corresponding to the vibration to the controller 50 in S21, S22, S23, and S24.

The controller 50 is configured to check whether the vibration detection signal matches the preset knock information in S25. For example, the controller 50 may be configured to identify the knock information based on the first and second vibration detection signals 201 and 204 resulting from the first and second knocks. In the knock information, at least one reference value Zth1, Zth2, and Zth3 may be defined based on magnitudes of the first and second vibration detection signals 201 and 204 resulting from the first and second knocks, and at least one reference period T1, T2, T3, T4, and T5 may be defined based on at least one residual vibration signal 202, 203, 205, and 206 resulting from the first and second knocks. The knock information may be stored in the memory 52.

In response to that the vibration detection signal matches the knock information, the controller 50 is configured to identify the knock fingerprint case in S26. In the present disclosure, identifying the knock fingerprint case may be defined as identifying the knock-on function matching the knock information in the map table stored in the memory 52.

In response to that it is identified that the knock-on function matching the knock information corresponds to an operation of matching the knock information corresponds to an operation of turning on and off the power of the cooktop, the controller 50 is configured to identify the power state of the cooktop in S27. The controller 50 is configured to check whether the power of the cooktop is activated in S28. In response to that the power of the cooktop is activated, the controller 50 is configured to turn off the power in S29. In response to that the power of the cooktop is deactivated, the controller 50 is configured to turn on the power in S30.

For example, in response to that the power of the cooktop is deactivated, the controller 50 may be configured to activate the control panel 40. In addition, in response to that the power of the cooktop is activated, the controller 50 may be configured to turn off the first and second heating zone 311 and 321 that are in operation.

In the present disclosure, for better understanding of the description, an example is illustrated in which the first heating zone 311, the second heating zone 321, the third heating zone 331, and the control panel 40 are disposed in the top plate 20. However, the present disclosure is not limited thereto.

The controller 50 may be configured to set the knock-on function so as to correspond to one of the various operations of the cooktop, including an operation of turning on or off cooktop power, an operation of turning off a most recently-set heating zone, an operation of turning off a specific heating zone, an operation of activating/deactivating temporary reduction of a heating intensity, an operation of lowering a heating intensity, an operation of setting a maximum heating intensity, an operation of setting/releasing a lock, an operation of setting a timer duration, and an operation of copying heating zone information. This setting of the knock-on function may be made in the user-specific manner.

The map table of the knock-on function may be stored in the memory 52. The operation of the cooktop corresponding to the knock-on function may be set for each user when knock information is generated in the above-described process of setting the knock-on function.

2) Operation of turning off the most recently-set heating zone

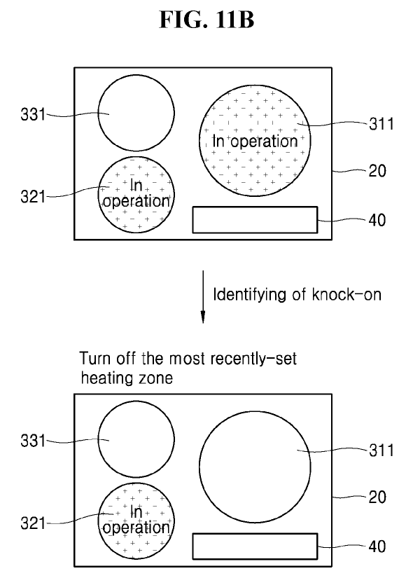

FIGS. 11A and 11B are diagrams illustrating a control flow of an operation of turning off the most recently-set heating zone corresponding to the knock-on function of the cooking appliance.

Referring to FIGS. 5, 6, 11A, and 11B, the vibration sensor 100 detects vibration caused by at least two user knocks and provides a vibration detection signal corresponding to the vibration to the controller 50 in S31, S32, S33, and S34.

The controller 50 is configured to check whether the vibration detection signal matches the preset knock information in S35. In response to that the vibration detection signal matches the knock information, the controller 50 is configured to identify the knock-on function matching the knock information in the map table stored in the memory 52 in S36.

When the knock-on function matching the knock information is identified as corresponding to the operation of turning off the most recently-set heating zone, the controller 50 is configured to check whether the cooktop is operating in S37. In this regard, the most recently-set heating zone may be defined as the heating zone whose an operation condition is most recently set by the user manipulating the cooktop.

In response to that the cooktop is operating, the controller 50 is configured to identify state information of the most recently-set heating zone in S38. In response to that the most recently-set heating zone is being activated in S39, the controller 50 is configured to turn off the most recently-set heating zone in S40.

In one example, when the first and second heating zones 311 and 321 among the first to third heating zones 311, 321, and 331 are in operation and the first heating zone 311 is the heating zone most recently-manipulated by the user, that is, the most recently-set heating zone, the controller 50 may be configured to turn off the first heating zone 311 among the first and second heating zones 311 and 321.

3) Operation of turning off specific heating zone

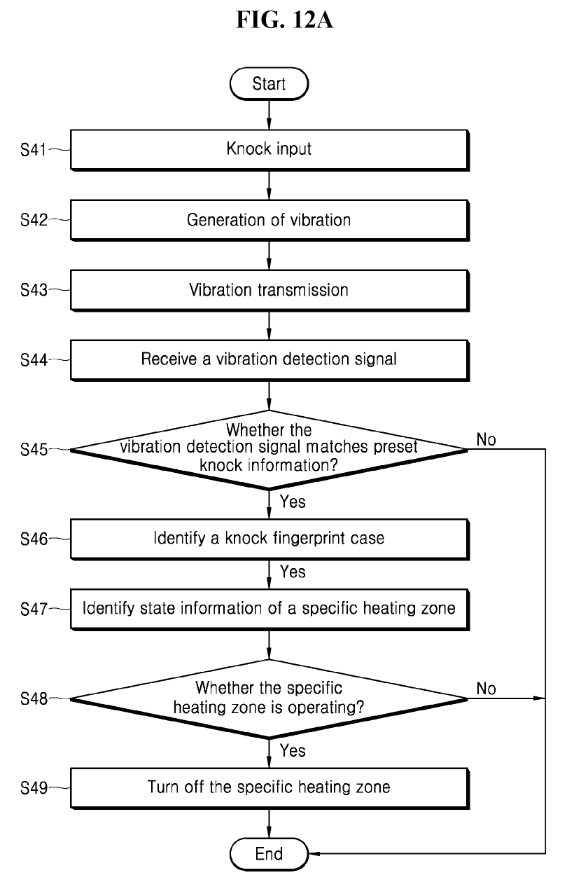

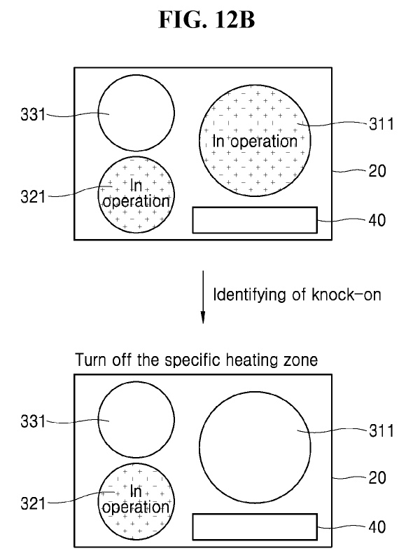

FIGS. 12A and 12B are diagrams illustrating a control flow of an operation of turning off a specific heating zone corresponding to the knock-on function of the cooking appliance.

Referring to FIGS. 5, 6, 12A, and 12B, the vibration sensor 100 detects vibration caused by at least two user knocks and provides a vibration detection signal corresponding to the vibration to the controller 50 in S41, S42, S43, and S44.

The controller 50 is configured to check whether the vibration detection signal matches the preset knock information in S45. In response to that the vibration detection signal matches the knock information, the controller 50 is configured to identify the knock-on function matching the knock information in the map table stored in the memory 52 in S46.

When the knock-on function matching the knock information is identified as corresponding to the operation of turning off the specific heating zone, the controller 50 is configured to identify state information of the specific heating zone in S47. In this regard, the specific heating zone may be set to one of the largest heating zone among the plurality of heating zones or the most recently-set heating zone, that is, the heating zone most recently manipulated by the user.

In response to that the specific heating zone among the plurality of heating zones is operating in S48, the controller 50 is configured to turn off the specific heating zone in S49.

In one example, when the first and second heating zones 311 and 321 among the first to third heating zones 311, 321, and 331 are in operation and the first heating zone 311 is the largest heating zone or the most recently-set heating zone, that is, the heating zone most recently manipulated by the user, the controller 50 may be configured to turn off the first heating zone 311.

4) Operation of activating/deactivating temporary reduction of heating intensity

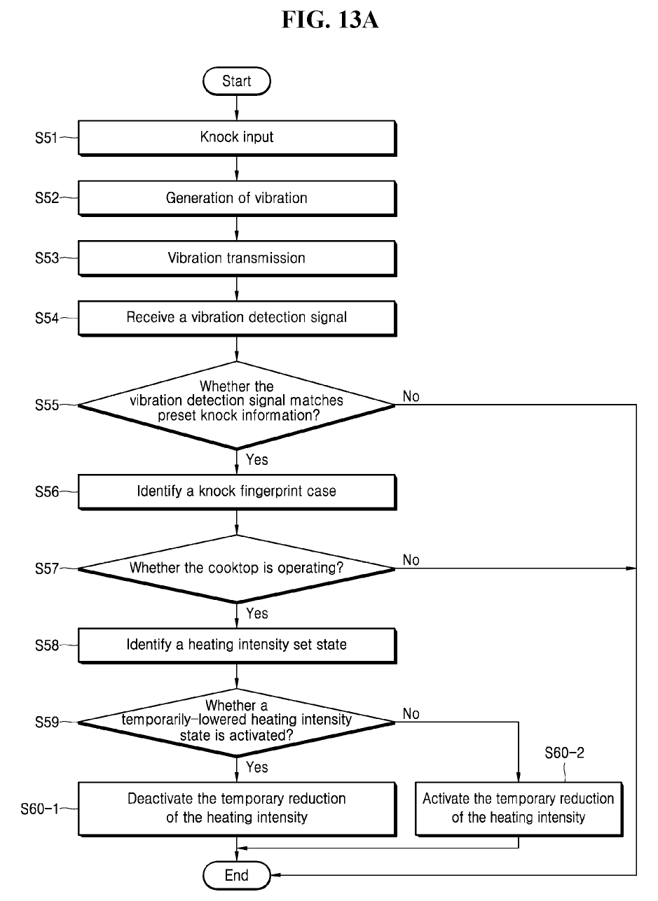

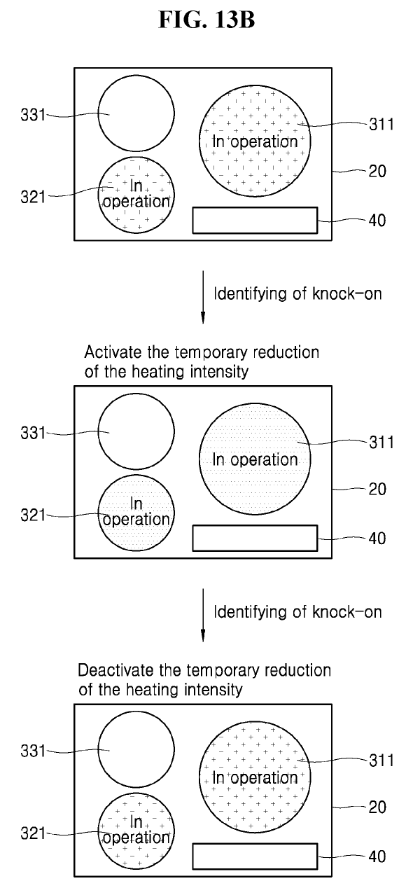

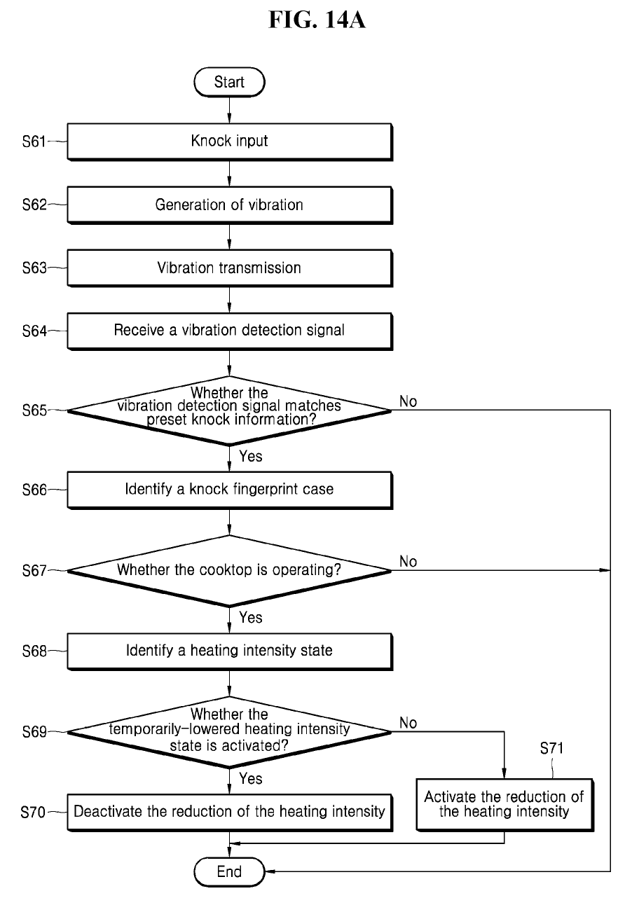

FIGS. 13A and 13B are diagrams illustrating a control flow of an operation of activating/deactivating temporary reduction of a heating intensity corresponding to the knock-on function of the cooking appliance.

Referring to FIGS. 5, 6, 13A, and 13B, the vibration sensor 100 detects vibration caused by at least two user knocks and provides a vibration detection signal corresponding to the vibration to the controller 50 in S51, S52, S53, and S54.

The controller 50 is configured to check whether the vibration detection signal matches the preset knock information in S55. In response to that the vibration detection signal matches the knock information, the controller 50 is configured to identify the knock-on function matching the knock information in the map table stored in the memory 52 in S56.

In response to that it is identified that the knock-on function matching the knock information corresponds to an operation of activating/deactivating temporary reduction of a heating intensity, the controller 50 is configured to check whether the cooktop is operating in S57. In response to that the cooktop is in operation, the controller 50 is configured to identify a heating intensity set state in S58. The controller 50 is configured to check whether a temporarily-lowered heating intensity state is activated in S59. In response to that the temporarily-lowered heating intensity state is activated, the controller 50 is configured to deactivate the temporary reduction of the heating intensity in S60-1. In response to that the temporarily-lowered heating intensity state is deactivated, the controller 50 is configured to activate the temporary reduction of the heating intensity in S60-2.

In one example, when the first and second heating zones 311 and 321 among the first to third heating zones 311, 321, and 331 are in operation, the controller 50 may be configured to temporarily lower the heating intensity of each of the first and second heating zones 311 and 321. In addition, when the first and second heating zones 311 and 321 are in the temporarily-lowered heating intensity state, the controller 50 may be configured to deactivate the temporary reduction of the heating intensity of each of the first and second heating zones 311 and 321 and change the heating intensity of each of the first and second heating zones 311 and 321 to the heating intensity before the temporarily-lowered heating intensity state.

5) Operation of lowering heating intensity

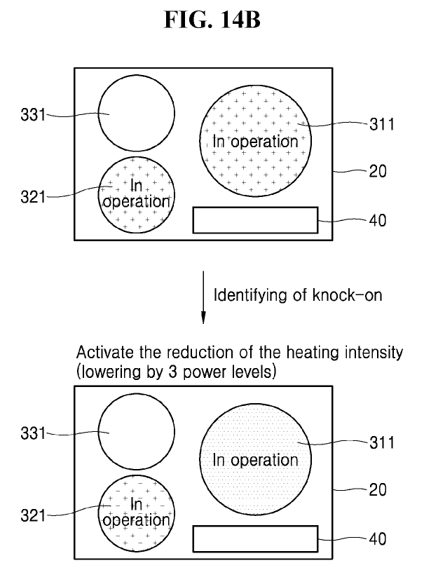

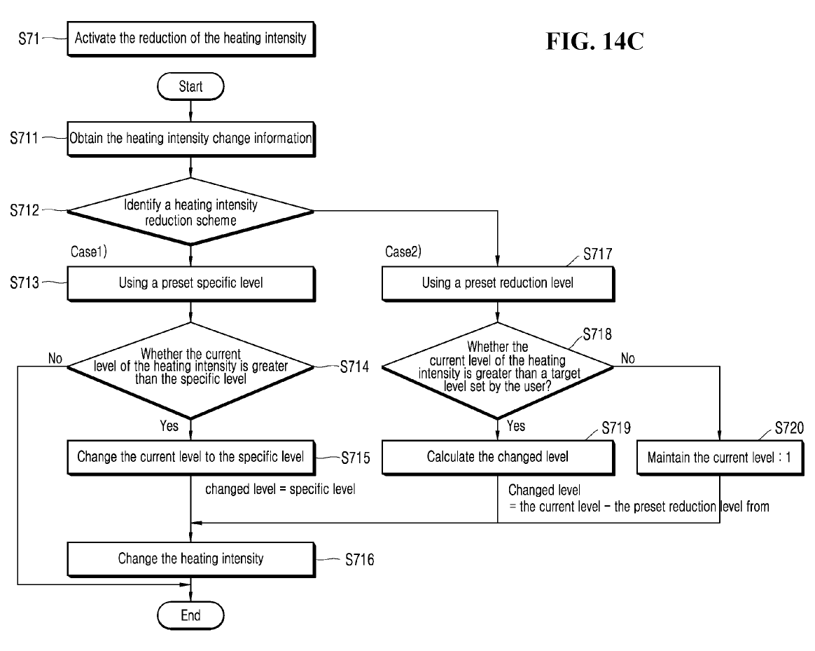

FIGS. 14A, 14B and 14C are diagrams illustrating a control flow of an operation of lowering a heating intensity corresponding to the knock-on function of the cooking appliance.

Referring to FIGS. 5, 6, 14A, 14B, and 14C, the vibration sensor 100 detects vibration caused by at least two user knocks and provides a vibration detection signal corresponding to the vibration to the controller 50 in S61, S62, S63, and S64.

The controller 50 is configured to check whether the vibration detection signal matches the preset knock information in S65. In response to that the vibration detection signal matches the knock information, the controller 50 is configured to identify the knock-on function matching the knock information in the map table stored in the memory 52 in S66.

In response to that it is identified that the knock-on function matching the knock information corresponds to an operation of lowering a heating intensity, the controller 50 is configured to check whether the cooktop is operating in S67. In response to that the cooktop is operating, the controller 50 is configured to identify the heating intensity state in S68. The controller 50 is configured to check whether the temporarily-lowered heating intensity state is activated in S69. In response to that the temporarily-lowered heating intensity state is activated, the controller 50 is configured to deactivate the reduction of the heating intensity in S70. In response to that the temporarily-lowered heating intensity state is deactivated, the controller 50 is configured to activate the reduction of the heating intensity in S71.

For example, in response to that the first and second heating zones 311 and 321 among the first to third heating zones 311, 321, and 331 are in operation, the controller 50 may be configured to lower the heating intensity of the first heating zone 311 which is the largest heating zone among the first and second heating zones 311 and 321 or the most recently-set heating zone, that is, the heating zone most recently manipulated by the user, by 3 power levels.

In activating the temporary reduction of the heating in S71, the controller 50 may be configured to change the heating intensity by lowering the current heating intensity level to a specific level in S711, S712, S713, S714, S715, and S716. Alternatively, the controller 50 may be configured to change the heating intensity by subtracting a preset level from the current heating intensity level in S711, S712, S717, S718, S719, and S720.

The controller 50 may be configured to obtain the heating intensity change information from the memory 52 in which the knock-on function is set in S711, and may identify a heating intensity reduction scheme from the heating intensity change information in S712.

In response to that the heating intensity reduction scheme uses a preset specific level in S713, the controller 50 may be configured to determine whether the current level of the heating intensity is greater than the specific level in S714. In response to that the current level of the heating intensity is greater than the specific level, the controller may be configured to change the current level to the specific level in S715 and thus change the heating intensity in S716.

Alternatively, in response to that the heating intensity reduction scheme uses a preset reduction level in S717, the controller 50 may be configured to determine whether the current level of the heating intensity is greater than a target level set by the user in S718. In response to that the current level of the heating intensity is greater than the target level, the controller may be configured to subtract the preset reduction level from the current level in S719. In response to that the current level of the heating intensity is lower than the target level, the controller may be configured to maintain the current level in S720.

6) Operation of setting Maximum Heating intensity

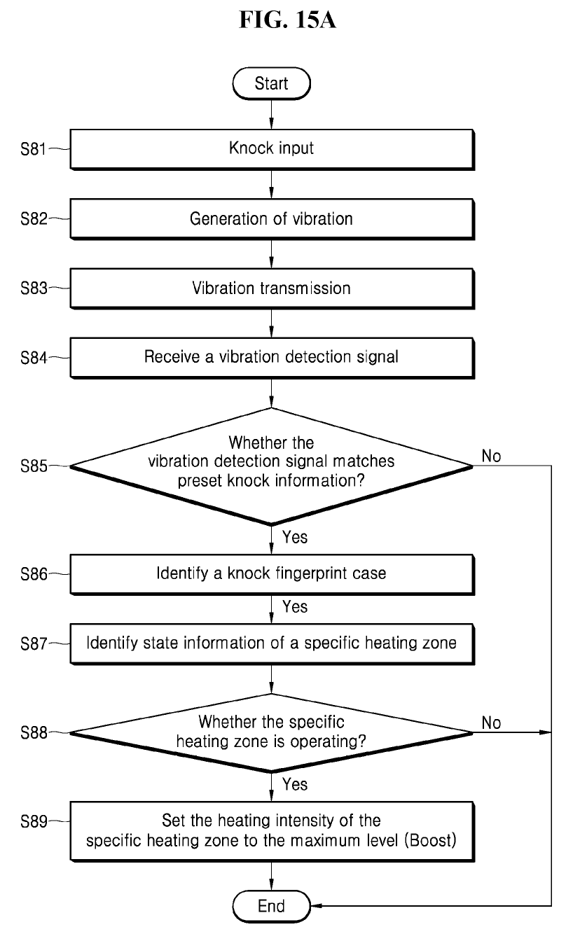

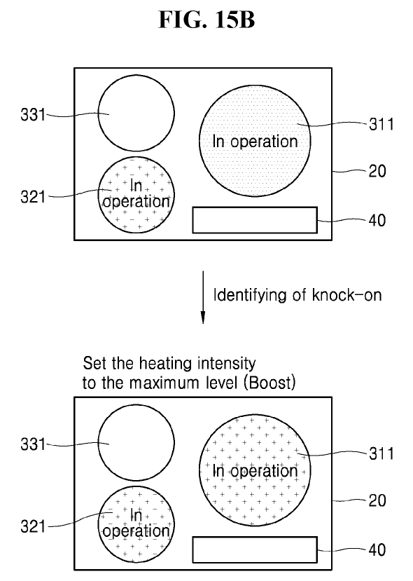

FIGS. 15A and 15B are diagrams illustrating a control flow of an operation of setting the maximum heating intensity corresponding to the knock-on function of the cooking appliance.

Referring to FIGS. 5, 6, 15A, and 15B, the vibration sensor 100 detects vibration caused by at least two user knocks and provides a vibration detection signal corresponding to the vibration to the controller 50 in S81, S82, S83, and S84.

The controller 50 is configured to check whether the vibration detection signal matches the preset knock information in S85. In response to that the vibration detection signal matches the knock information, the controller 50 is configured to identify the knock-on function matching the knock information in the map table stored in the memory 52 in S86.

In response to that the knock-on function is identified as corresponding to setting the maximum heating intensity, the controller 50 is configured to identify state information of a specific heating zone in S87. In response to that the specific heating zone is operating in S88, the controller 50 is configured to set the heating intensity of the specific heating zone to the maximum level in S89.

In one example, in response to that the first and second heating zones 311 and 321 among the first to third heating zones 311, 321, and 331 are in operation and the first heating zone 311 is the specific heating zone, the controller 50 may be configured to set the heating intensity of the first heating zone 311 to the maximum heating intensity level. In this regard, the specific heating zone may be set as the largest heating zone among the plurality of heating zones, the most recently-set heating zone most recently manipulated by the user in the process of using the cooktop, or the heating zone designated by the user when the user sets the knock-on function.

7) Operation of setting/releasing lock

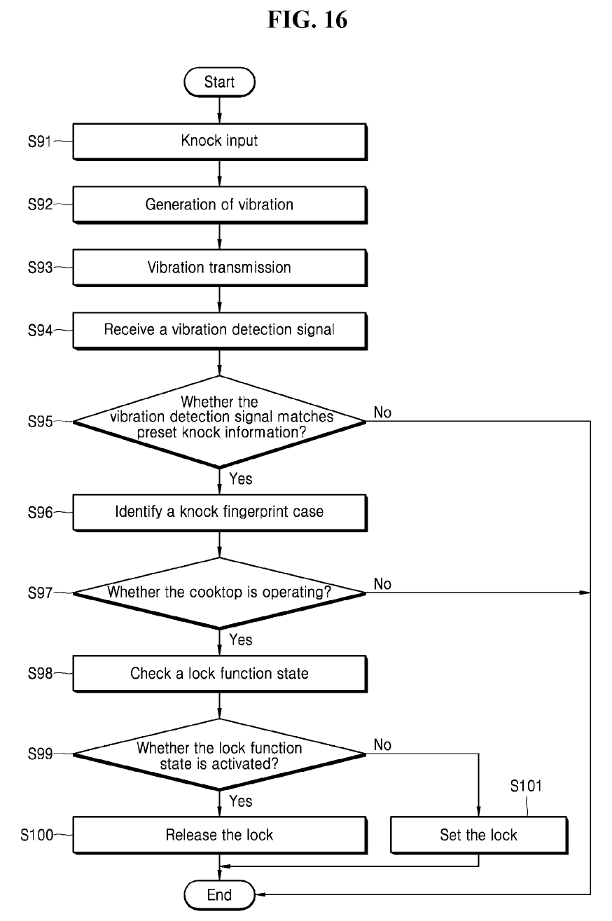

FIG. 16 is a diagram illustrating a control flow of an operation of setting/releasing a lock corresponding to the knock-on function of the cooking appliance.

Referring to FIGS. 5, 6 and 16, the vibration sensor 100 detects vibration caused by at least two knock inputs from the user, and provides a vibration detection signal corresponding to the vibration to the controller 50 in S91, S92, S93, and S94.

The controller 50 is configured to check whether the vibration detection signal matches the preset knock information in S95. In response to that the vibration detection signal matches the knock information, the controller 50 is configured to identify the knock-on function matching the knock information in the map table stored in the memory 52 in S96.

In response to that it is identified that the knock-on function matching the knock information is identified as corresponding to an operation of setting/releasing a lock, the controller 50 is configured to check whether the cooktop is operating in S97. In response to that the cooktop is operating, the controller 50 is configured to check a lock function state in S98.

The controller 50 is configured to check whether the lock function state is activated in S99. In response to that the lock function state is activated, the controller 50 is configured to release the lock in S100. In response to that the lock function state is deactivated, the controller 50 is configured to set the lock in S101.

8) Operation of setting timer duration

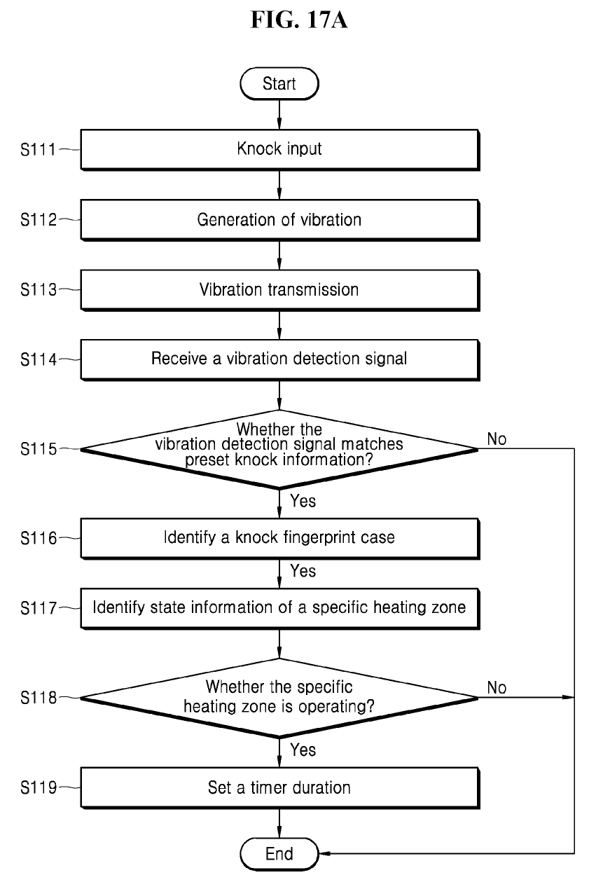

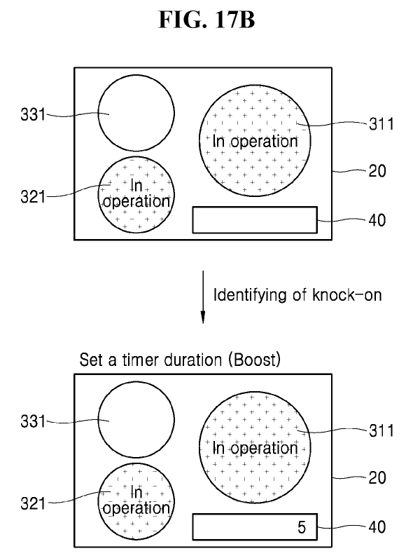

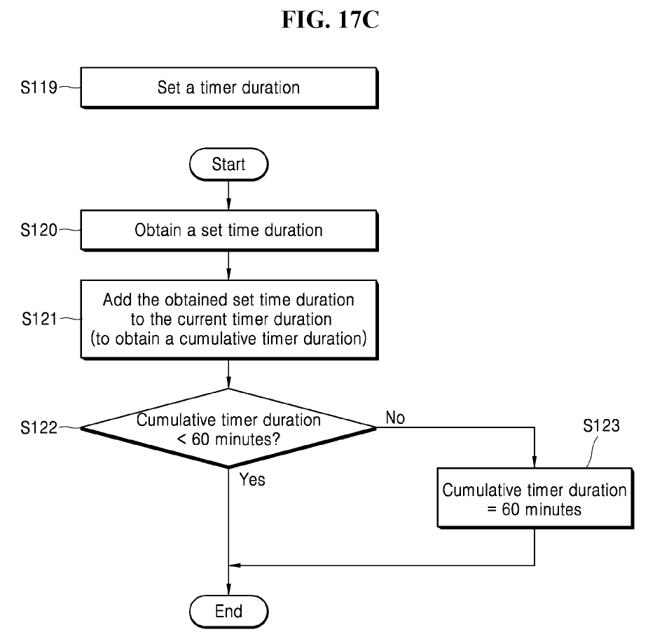

FIGS. 17A, 17B, and 17C, are diagrams illustrating a control flow of an operation of setting a timer duration corresponding to the knock-on function of the cooking appliance.

Referring to FIGS. 5, 6, 17A, 17B, and 17C, the vibration sensor 100 detects vibration caused by at least two user knocks and provides a vibration detection signal corresponding to the vibration to the controller 50 in S111, S112, S113, and S114.

The controller 50 is configured to check whether the vibration detection signal matches the preset knock information in S115. In response to that the vibration detection signal matches the knock information, the controller 50 is configured to identify the knock-on function matching the knock information in the map table stored in the memory 52 in S116.

In response to that the knock-on function matching the knock information is identified as corresponding to an operation of setting the timer duration, the controller 50 is configured to identify state information of a specific heating zone in S117. In response to that the specific heating zone is in operation, the controller 50 is configured to set the timer duration in S119. The specific heating zone may be set as the largest heating zone among a plurality of heating zones, the most recently-set heating zone most recently manipulated by the user in the process of using the cooktop, or the heating zone designated by the user when the user sets the knock-on function.

For example, in response to that the first and second heating zones 311 and 321 among the first to third heating zones 311, 321, and 331 are in operation and the first heating zone 311 is set as the specific heating zone, the controller 50 may be configured to set a timer duration of the first heating zone 311 set as the specific heating zone to 5 minutes. The timer duration may be displayed on the control panel 40. In response to that a knock is additionally input from the user, 5 minutes may be added to the current timer duration such that a total cumulative timer duration may be set to 10 minutes. In one example, the total cumulative timer duration may be set to a maximum of 60 minutes.

In setting the timer duration in S119, the controller 50 may be configured to obtain a set time duration from the memory 52 in which the knock-on function is set in S120, and to add the obtained set time duration to the current timer duration in S121. In this regard, the time duration obtained by adding the obtained set time duration to the current timer duration is referred to as a cumulative timer duration.

The controller 50 may be configured to determine whether the cumulative timer duration is smaller than 60 minutes in S122. In response to that the cumulative timer duration is greater than 60 minutes, the controller is configured to adjust the cumulative timer duration to 60 minutes in S123.

As described above, according to the present disclosure, one of various operations of the cooktop matching the knock information may be performed only with the user knocking on the top plate of the cooktop while the cooktop is operating.

In addition, the control apparatus and the control method of the present disclosure may perform at least one of an operation of turning on or off cooktop power, an operation of turning off a most recently-set heating zone, an operation of turning off a specific heating zone, an operation of activating/deactivating temporary reduction of a heating intensity, an operation of lowering a heating intensity, an operation of setting a maximum heating intensity, an operation of setting/releasing a lock, an operation of setting a timer duration, and an operation of copying heating zone information in response to the user knocking on the top plate of the cooktop.

In addition, the control apparatus and the control method of the present disclosure may control the operation of the cooktop with the user knocking on the top plate of the cooktop while performing the cooking operation, thereby improving user convenience.

During the cooking process, it may be difficult for the user to manipulate the cooktop. For example, the food residue may be present on the hand of the user. In the event that the cooking type involves preparing deep-fried food, a large amount of oil may be splashed on the top surface of the cooktop. In this case, it may be reluctant for the user to touch the control panel multiple times. However, in the cooking appliance of the present disclosure, using the knock-on function, the user may easily manipulate the cooktop for a user-defined function or a frequently used function.

In addition, the control apparatus and the control method of the present disclosure may allow the operations of the cooking appliance controlled by the knock-on function to be various via personalization of the knock information.

In addition, the control apparatus and the control method of the present disclosure may easily add an additional operation of the cooking appliance controlled by the knock-on function via the update of the application or the cooking appliance.

9) Operation of copying heating zone information

The present disclosure provides an apparatus and a method for controlling a cooking appliance capable of controlling an operation of copying information on a heating zone of a cooktop with only manipulation in which the user knocks on an upper plate of the cooktop while performing the cooking process.

In the present disclosure, the operation of copying the heating zone information corresponding to the knock-on function may be defined as an operation of activating or operating a new second heating zone based on operation information of a first heating zone in an operating or activated state. In this regard, the operation information of the heating zone may include at least one of a heating intensity level and a timer duration.

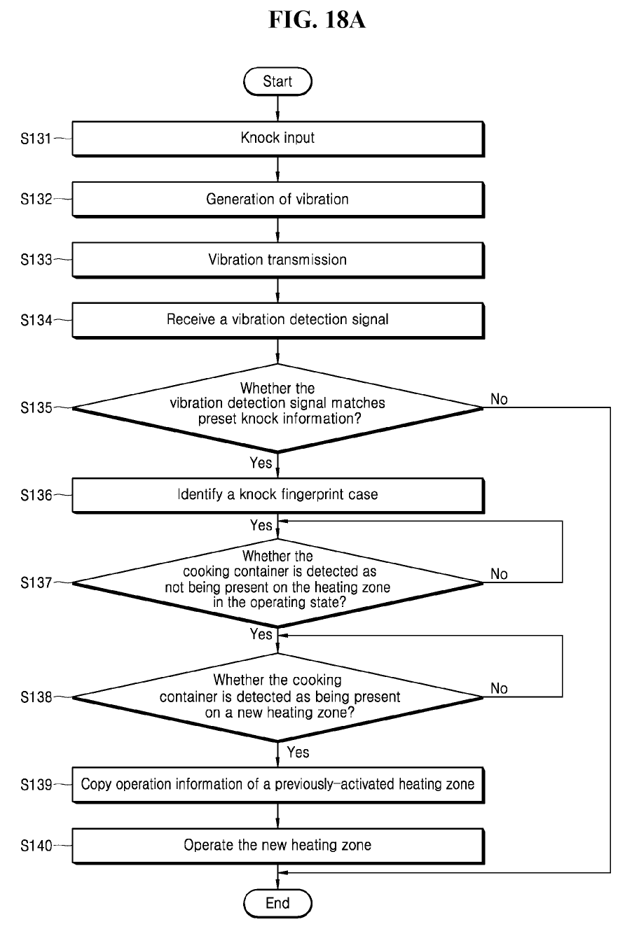

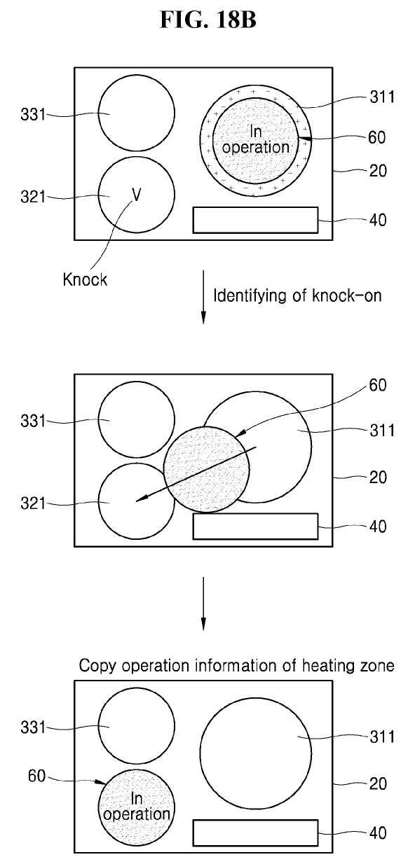

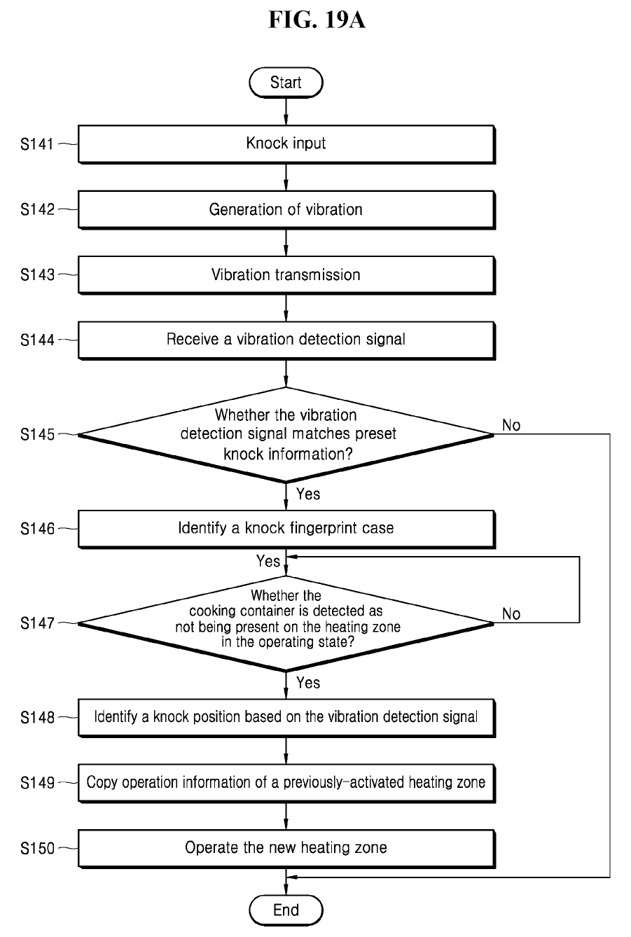

FIGS. 18A and 18B show an embodiment of a control flow of an operation of copying the heating zone information corresponding to the knock-on function of the cooking appliance.

Referring to FIGS. 5, 6, 18A and 18B, the controller 50 detects vibration caused by at least two user knocks from the vibration sensor 100 and receives a vibration detection signal corresponding to the vibration in S131, S132, S133, and S134.

The controller 50 is configured to check whether the vibration detection signal matches the preset knock information in S135. In response to that the vibration detection signal matches the knock information, the controller 50 is configured to identify the knock fingerprint case in S136. For example, the controller 50 is configured to identify a knock-on function matching the knock information in the map table stored in the memory 52 in S136.

The controller 50 is configured to receive the container detection signal from the container detection sensor 210, and checks whether the cooking container 60 is detected as not being present on the heating zone in the operating state, based on the container detection signal in S137. In this regard, in response to that it is identified that a heating zone on which the cooking container 60 is seated is not detected, the controller 50 may be configured to determine the heating zone as a heating zone to operate under the copied operation information.

The controller 50 is configured to check whether the cooking container 60 is detected as being present on the new heating zone, based on the container detection signal in S138. In this regard, in response to that it is identified that the cooking container 60 is detected as being present on the new heating zone, the controller 50 may be configured to determine the heating zone as a heating zone to operate under the copied operation information obtained by copying the heating zone operation information.

The controller 50 copies operation information of a heating zone on which the cooking container is detected as being absent among the heating zones in which the heating operation is in progress in S139. In this regard, copying the operation information of the heating zone may be defined as reading out at least one of the heating intensity or the timer duration as the operation information of the previously-activated heating zone, from the memory.

The controller 50 operates the new heating zone on which the cooking container 60 is detected as being present, under the operation information of the previously-activated heating zone in S140.

In one example, in a state in which the first heating zone 311 of the first to third heating zones 311, 321, and 331 is in operation or in the activated state, and the cooking container 60 is seated on the first heating zone 311, the user inputs the knock V onto the second heating zone 321 at least twice. In this response, the controller 50 is configured to check whether the cooking container 60 is detected as being absent on the first heating zone 311, based on the container detection signal.

In response to that it is identified, based on the container detection signal, that the cooking container 60 is detected as being absent on the first heating zone 311 in the activated state, and the cooking container 60 is detected as being present on the second heating zone 321, the controller 50 may be configured to operate the second heating zone 321 using the operation information of the first heating zone 311. In this regard, the controller 50 may be configured to turn off the first heating zone 311.

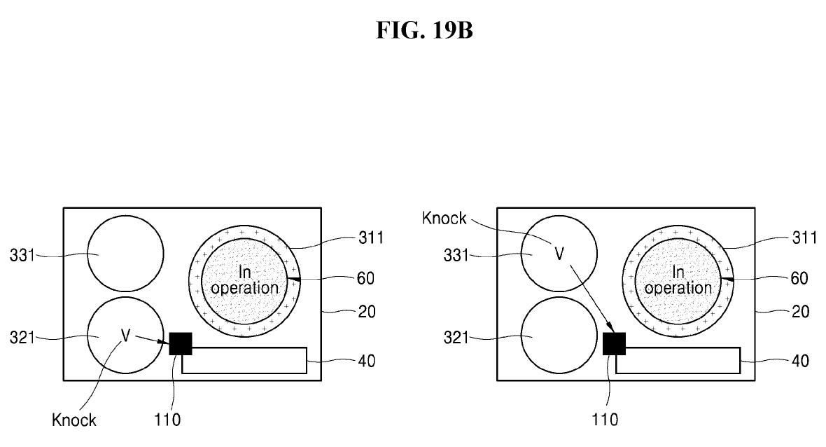

FIGS. 19A and 19B show another embodiment illustrating a control flow of an operation of copying the heating zone information corresponding to the knock-on function of the cooking appliance.

Referring to FIGS. 5, 6, 19A and 19B, the controller 50 detects vibration caused by at least two user knocks from the vibration sensor 100 and receives a vibration detection signal corresponding to the vibration in S141, S142, S143, and S144.

The controller 50 is configured to check whether the vibration detection signal matches the preset knock information in S145. In response to that the vibration detection signal matches the knock information, the controller 50 is configured to identify the knock fingerprint case in S146. For example, the controller 50 is configured to identify a knock-on function matching the knock information in the map table stored in the memory 52 in S146.

The controller 50 is configured to receive the container detection signal from the container detection sensor 210, and check whether the cooking container 60 is detected as being absent on the heating zone in the activated state, based on the container detection signal in S147. In this regard, the controller is configured to identify the knock detection signal resulting from the knock, and then, determine whether the cooking container 60 is detected as being absent on the heating zone in the activated state. In this case, upon determination that the cooking container 60 is detected as being absent on the heating zone in the activated state, the controller 50 may be configured to determine the heating zone in the activated state as the heating zone whose the operation information is to be copied.

The controller 50 is configured to identify a knock position based on the vibration detection signal in S148. For example, the controller 50 may be configured to identify the knock position based on a ratio between the magnitude of the reference value defined in the knock information and the magnitude of the vibration detection signal. In the knock information, at least one reference value Zth1, Zth2, and Zth3 may be defined based on magnitudes of the first and second vibration detection signals 201 and 204 resulting from the first and second knocks, and at least one reference period T1, T2, T3, T4, and T5 may be defined based on at least one residual vibration signal 202, 203, 205, and 206 resulting from the first and second knocks.

The controller 50 may be configured to calculate the ratio between the magnitude of the first and second vibration detection signals 201 and 204 resulting from the first and second knocks and the magnitude of the reference value Zth1, Zth2, and Zth3 defined in the knock information, and determine the knock position based on the calculated ratio. The vibration transmission path length and the vibration magnitude are inversely proportional to each other. As the distance between the heating zone and the vibration sensor 110 increases, the vibration detected in the heating zone may be smaller due to the vibration attenuation.

For example, the vibration sensor 110 may be disposed adjacent to the control panel 40. Among the respective distances between the vibration sensor 110 and the heating zones 311, 321, and 331, the distance between the vibration sensor 110 and the second heating zone 321 may be the shortest, and the distance between the vibration sensor 110 and the third heating zone 331 may be the greatest.

For example, in a state in which the first heating zone 311 among the first to third heating zones 311, 321, and 331 is in operation and the cooking container 60 is seated on the first heating zone 311, a case in which the user inputs the knock V onto the second heating zone 321 at least twice and a case in which the user inputs the knock V onto the third heating zone 331 at least twice may be compared with each other by way of example.

The magnitude of the vibration detection signal detected by the vibration sensor 110 in response to that the user inputs the knock V onto the third heating zone 331 at least twice may be smaller than the magnitude of the vibration detection signal detected by the vibration sensor 110 in response to that the user inputs the knock V onto the second heating zone 321 at least twice. In this manner, the controller 50 may be configured to identify the knock position based on the magnitude of the vibration detection signal.

The controller 50 may be configured to determine the heating zone corresponding to the knock position as the heating zone to be operated or activated. In identifying the knock position, the controller 50 may be configured to determine one of the

non-operating heating zones as the knock position except for the currently-operating heating zone, based on the magnitude of the vibration detection signal,.

The controller 50 is configured to copy operation information of the heating zone on which the cooking container is detected as being absent among the heating zones in the activated state in S149. Then, the controller 50 is configured to operate a new heating zone on which the cooking container is detected as being present, using the operation information of the previously-activated heating zone, that is, the copied operation information in S150.

As described above, according to the present disclosure, while the cooking appliance is performing the cooking operation, the operation information of the operating heating zone may be copied and another heating zone may be operated using the copied operation information, only via the manipulating of knocking on the top surface of the cooktop.

In addition, the control apparatus and the control method of the present disclosure may accurately determine the heating zone whose the operation information is to be copied, based on the container detection signal.

In addition, the control apparatus and the control method of the present disclosure may identify the knock position based on the vibration detection signal, and determine the heating zone corresponding to the knock position as the heating zone to be operated using the copied operation information.

In addition, the control apparatus and the control method of the present disclosure may accurately determine the location of the knock based on the ratio between the magnitude of the vibration defined in the knock information and the magnitude of the vibration detection signal, thereby accurately determining the heating zone to be operated or activated using the copied operation information.

In addition, the control apparatus and the control method of the present disclosure may control the operation of copying the information on the heating zone of the cooktop via the manipulation of knocking on the top plate of the cooktop while performing the cooking process, thereby improving user convenience.

According to one aspect of the present disclosure, provided is an apparatus for controlling a cooking appliance, the apparatus comprising: a vibration sensor configured to detect vibration resulting from at least two times of knocks and provide a vibration detection signal corresponding to the detected vibration to a controller; a container detection sensor configured to detect a cooking container and provide a container detection signal to the controller; and the controller configured to: identify a knock-on function matching preset knock information, based on the received vibration detection signal; determine a first heating zone whose operation information is to be copied, based on the received container detection signal; copy the operation information of the first heating zone; and operate a second heating zone using the copied operation information of the first heating zone.

In accordance with some embodiments of the apparatus, the controller is configured to determine, as the first heating zone, a heating zone in an operating state on which the cooking container is detected as being absent, based on the container detection signal.

In accordance with some embodiments of the apparatus, the controller is configured to determine the second heating zone, based on at least one of the container detection signal or the vibration detection signal.

In accordance with some embodiments of the apparatus, the controller is configured to determine, as the second heating zone, a heating zone on which the cooking container is detected as being present, based on the container detection signal.

In accordance with some embodiments of the apparatus, the controller is configured to identify a knock position based on the vibration detection signal, and determine a heating zone corresponding to the knock position as the second heating zone.

In accordance with some embodiments of the apparatus, the controller is configured to identify the knock position based on a ratio between a magnitude of a reference value defined in the knock information and a magnitude of the vibration detection signal.

In accordance with some embodiments of the apparatus, the controller configured to identify the knock position is further configured to determine a position of one of non-operating heating zones except for an operating heating zone as the knock position, based on the magnitude of the vibration detection signal.

In accordance with some embodiments of the apparatus, in the knock information, a first reference value is set based on a magnitude of a first vibration detection signal resulting from a first knock, second and third reference values are set based on a magnitude of a second vibration detection signal resulting from a second knock, and at least one reference period is set based on an interval between the first knock and the second knock.

In accordance with some embodiments of the apparatus, the third reference value is set based on a magnitude of a residual vibration signal detected when a predetermined period of time has elapsed after the second knock.

In accordance with some embodiments of the apparatus, the second reference value is set to be greater than the first reference value, and the third reference value is set to be smaller than the first reference value.

According to another aspect of the present disclosure, provided is a method of controlling a cooking appliance, the method comprising: identifying a knock-on function matching preset knock information, based on a vibration detection signal received from a vibration sensor; determining a first heating zone whose operation information is to be copied, based on a container detection signal received from a container detection sensor; copying the operation information of the first heating zone; determining a second heating zone, based on at least one of the container detection signal or the vibration detection signal, wherein the second heating zone is a heating zone to operate using the copied operation information of the first heating zone; and operating the second heating zone using the copied operation information of the first heating zone.

In accordance with some embodiments of the method, the determining of the first heating zone includes determining, as the first heating zone, a heating zone in an operating state on which a cooking container is detected as being absent, based on the container detection signal.

In accordance with some embodiments of the method, the determining the second heating zone includes determining, as the second heating zone, a heating zone on which the cooking container is detected as being present, based on the container detection signal.

In accordance with some embodiments of the method, the determining of the second heating zone includes: identifying a knock position based on the vibration detection signal; and determining a heating zone corresponding to the knock position as the second heating zone.

In accordance with some embodiments of the method, the identifying of the knock position includes identifying the knock position based on a ratio between a magnitude of a reference value defined in the knock information and a magnitude of the vibration detection signal. In accordance with some embodiments of the method, the identifying of the knock position includes determining a position of one of non-operating heating zones except for an operating heating zone as the knock position, based on a magnitude of the vibration detection signal.

Although embodiments of the present disclosure have been described with reference to the accompanying drawings, the present disclosure is not limited to the above embodiments, but may be implemented in various different forms. A person skilled in the art may appreciate that the present disclosure may be practiced in other concrete forms without changing the technical spirit or essential characteristics of the present disclosure. Therefore, it should be appreciated that the embodiments as described above are not restrictive but illustrative in all respects.

What is claimed is:

1. An apparatus for controlling a cooking appliance, the apparatus comprising:
a vibration sensor configured to detect vibration resulting from at least two times of knocks and provide a vibration detection signal corresponding to the detected vibration to a controller;
a container detection sensor configured to detect a cooking container and provide a container detection signal to the controller; and
the controller configured to:
identify a knock-on function matching preset knock information, based on the received vibration detection signal;
determine a first heating zone whose operation information is to be copied, based on the received container detection signal;
copy the operation information of the first heating zone; and
operate a second heating zone using the copied operation information of the first heating zone.

2. The apparatus of claim 1, wherein the controller is configured to determine, as the first heating zone, a heating zone in an operating state on which the cooking container is detected as being absent, based on the container detection signal.

3. The apparatus of claim 1, wherein the controller is configured to determine the second heating zone, based on at least one of the container detection signal or the vibration detection signal.

4. The apparatus of claim 3, wherein the controller is configured to determine, as the second heating zone, a heating zone on which the cooking container is detected as being present, based on the container detection signal.

5. The apparatus of claim 3, wherein the controller is configured to identify a knock position based on the vibration detection signal, and determine a heating zone corresponding to the knock position as the second heating zone.

6. The apparatus of claim 5, wherein the controller is configured to identify the knock position based on a ratio between a magnitude of a reference value defined in the knock information and a magnitude of the vibration detection signal.

7. The apparatus of claim 5, wherein the controller configured to identify the knock position is further configured to determine a position of one of non-operating heating zones except for an operating heating zone as the knock position, based on the magnitude of the vibration detection signal.

8. The apparatus of claim 1, wherein in the knock information, a first reference value is set based on a magnitude of a first vibration detection signal resulting from a first knock, second and third reference values are set based on a magnitude of a second vibration detection signal resulting from a second knock, and at least one reference period is set based on an interval between the first knock and the second knock.

9. The apparatus of claim 8, wherein the third reference value is set based on a magnitude of a residual vibration signal detected when a predetermined period of time has elapsed after the second knock.

10. The apparatus of claim 9, wherein the second reference value is set to be greater than the first reference value, and the third reference value is set to be smaller than the first reference value.

11. A method of controlling a cooking appliance, the method comprising:
identifying a knock-on function matching preset knock information, based on a vibration detection signal received from a vibration sensor;
determining a first heating zone whose operation information is to be copied, based on a container detection signal received from a container detection sensor;
copying the operation information of the first heating zone;
determining a second heating zone, based on at least one of the container detection signal or the vibration detection signal, wherein the second heating zone is a heating zone to operate using the copied operation information of the first heating zone; and
operating the second heating zone using the copied operation information of the first heating zone.

12. The method of claim 11, wherein the determining of the first heating zone includes determining, as the first heating zone, a heating zone in an operating state on which a cooking container is detected as being absent, based on the container detection signal.

13. The method of claim 12, wherein the determining the second heating zone includes determining, as the second heating zone, a heating zone on which the cooking container is detected as being present, based on the container detection signal.

14. The method of claim 12, wherein the determining of the second heating zone includes:
identifying a knock position based on the vibration detection signal; and
determining a heating zone corresponding to the knock position as the second heating zone.

15. The method of claim 14, wherein the identifying of the knock position includes identifying the knock position based on a ratio between a magnitude of a reference value defined in the knock information and a magnitude of the vibration detection signal.

16. The method of claim 14, wherein the identifying of the knock position includes determining a position of one of non-operating heating zones except for an operating heating zone as the knock position, based on a magnitude of the vibration detection signal.
